(19) United States
(12) Patent Application Publication
(10) Pub. No.: US 2025/0290307 A1
(43) Pub. Date: Sep. 18, 2025

(54) MODULAR FURNITURE SYSTEM

(71) Applicant: 2724889 ONTARIO INC., Oakville (CA)

(72) Inventors: Jacek STYRC, Oakville (CA); Sebastian LYSIAK, Bielsko-Biala (PL)

(21) Appl. No.: 19/059,409

(22) Filed: Feb. 21, 2025

Related U.S. Application Data
(63) Continuation of application No. 18/488,264, filed on Oct. 17, 2023.
Application No. 18/488,264 is a continuation of application No. 17/501,650, filed on Oct. 14, 2021, now Pat. No. 11,828,056.
Application No. 17/501,650 is a continuation of application No. 16/849,075, filed on Apr. 15, 2020, now Pat. No. 11,214,954.
Application No. 16/849,075 is a continuation of application No. 16/485,272, filed on Aug. 12, 2019, now Pat. No. 10,858,819.
Application No. 16/485,272 is a continuation of application No. 15/815,973, filed on Nov. 17, 2017, now abandoned.
(60) Provisional application No. 62/461,308, filed on Feb. 21, 2017.
(60) Provisional application No. 62/461,308, filed on Feb. 21, 2017.

(51) Int. Cl. E04B 1/19; A45F 3/24; E04B 1/00; E04B 1/26; E04B 1/38; E04B 1/58; E04F 10/02; E04F 10/08; F16M 11/24

(52) U.S. Cl. CPC E04B 1/1912; A45F 3/24; E04B 1/0046; E04B 1/2608; E04F 10/02; E04F 10/08; F16M 11/24; E04B 2001/1963; E04B 2001/1984; E04B 2001/199; E04B 2001/1993; E04B 2001/2644; E04B 2001/266; E04B 2001/2676; E04B 2001/2684; E04B 2001/389; E04B 1/5831; E04B 2001/5887

(57) ABSTRACT

A modular framework having a plurality of elongate structural members interconnected by brackets is provided. Each of the brackets includes at least one tubular socket to receive a structural member, and an array of holes is provided on a face of the socket to permit connection of an attachment to the bracket to support ancillary components.

### FIELD OF THE INVENTION

The present invention relates to a modular furniture system, primarily, though not exclusively for outdoor use.

### DESCRIPTION OF THE PRIOR ART

The benefit of being able to spend time outdoors is well known but in a modern urban environment these benefits are not always readily available. It is recognised that excessive exposure to sun can be detrimental but natural shade is not always available. Similarly, relaxing in a hammock is an idyllic way to enjoy the outdoors but a hammock requires robust support to be safe and this is not always available.

Various attempts have been made to provide an enjoyable outdoor environment, such as pergolas to provide shade and dedicated free standing support frames for hammocks. These are effective but in the case of a pergola it is necessary to construct a dedicated structure that is not readily moved or stored. Whilst kits are available they consist of precut or prefabricated wooden components that require specialised tools and expertise to assemble.

Similarly, the support frame for a hammock is cumbersome and has a significant footprint even when not in use.

It is therefore an object of the present invention to obviate or mitigate the above disadvantages.

### SUMMARY OF THE INVENTION

In general terms, the present invention provides a modular frame work having a plurality of elongate structural members interconnected by brackets. Each of the brackets includes at least one tubular socket to receive a structural member. An array of holes is provided on a face of the socket to permit connection of an attachment to the bracket to support ancillary components.

Preferably, the array of holes is arranged in two parallel rows spaced from one another with the holes in each row uniformly spaced apart to define a grid.

The brackets may also have a plurality of orthogonally disposed sockets with an array of holes on inwardly directed faces of respective sockets.

As a further preference, the sockets are rectilinear in cross section.

### BRIEF DESCRIPTION OF THE DRAWINGS

8 An embodiment of the invention will now be described by way of example only with reference to the accompanying drawings in which:—

FIG. 1 is a perspective view of a frame work to provide shade

FIG. 2 is a perspective view of a frame work similar to FIG. 1 in which support for a hammock is provided,

FIG. 3 is a perspective view of the framework of FIG. 1 used to provide shade and privacy;

FIG. 4 is a perspective view of a framework connected to a surrounding structure;

FIG. 5 is a perspective view of a framework providing support for a pergola;

FIG. 6 is a schematic representation of an expanded framework similar to FIG. 2,

FIG. 7 is a perspective view similar to FIG. 6 showing a further expansion of the framework

FIG. 8 is a view of the framework of FIG. 1 with an alternate fastening

FIG. 9 is a schematic representation of the frame shown in FIG. 4 expanded.

FIG. 10 is a perspective view of a bracket used in the framework of FIG. 1

FIG. 11 is a plan view of one corner of the framework of FIG. 1,

FIG. 12 is a perspective view of a hanger used in the corner shown in FIG. 11

FIG. 13 is a perspective view of a foot used in FIG. 1

FIG. 14 is a plan view of a collar used in the embodiment of FIG. 2

FIG. 15 is a perspective view of the collar of FIG. 14

FIG. 16 is a perspective view of a clip used in the framework of FIG. 3

FIG. 17 is a perspective view of a bracket connecting 4 structural members,

FIG. 18 is a perspective view of a connector for joining structural members, and,

FIG. 19 is a perspective view of a bracket to connect 5 structural members orthogonally.

### DETAILED DESCRIPTION OF THE INVENTION

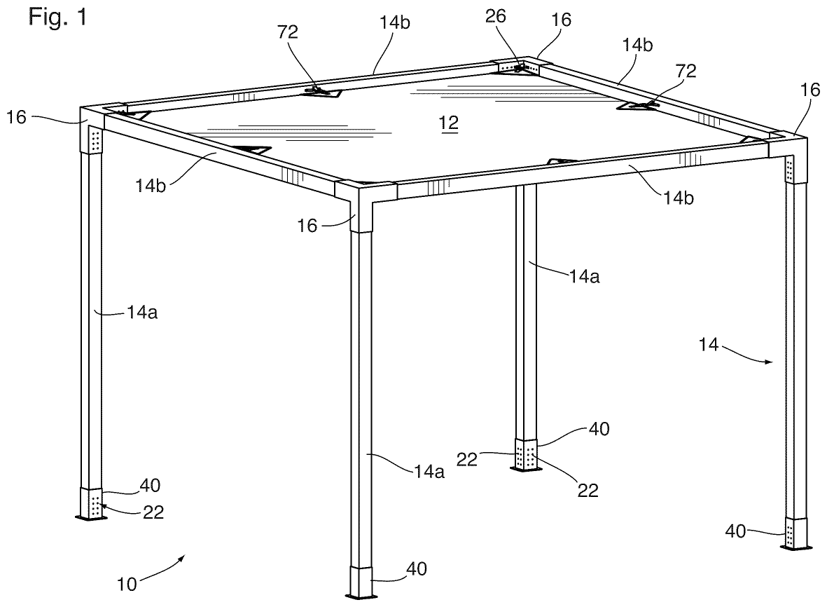

Referring to FIG. 1, a modular framework 10 is used to support a shade cloth 12 to provide a shaded area. The framework 10 consists of a plurality of elongate structural members 14 that are connected at the interstices of the framework 10 by brackets 16. The number of structural members 14 an their orientation will depend on the structure required, as illustrated in the alternative embodiments below, and similarly the number and configuration of the brackets will depend on the form of the structure 10.

Each of the structural members 14 is formed from a dimensional material, typically wood although other materials such as metal or plastics could be used. Preferably, the members 14 are a weather resistant wood in a readily available cross section such as a nominal 4″×4′ pressure treated lumber or cedar. Alternative dimensions may be used, such as a nominal 6″×6″ lumber or an extruded aluminum 2×2 or 3×3 section.

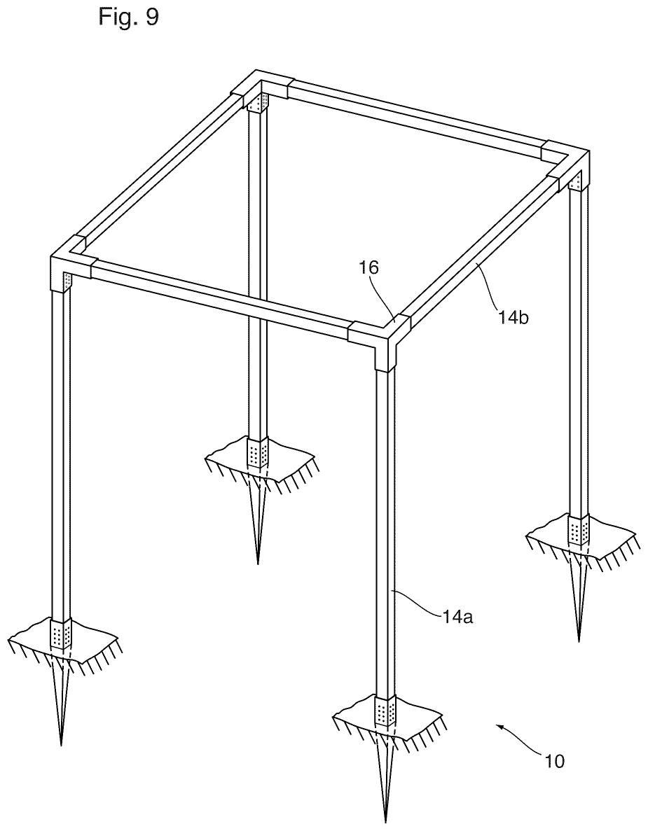

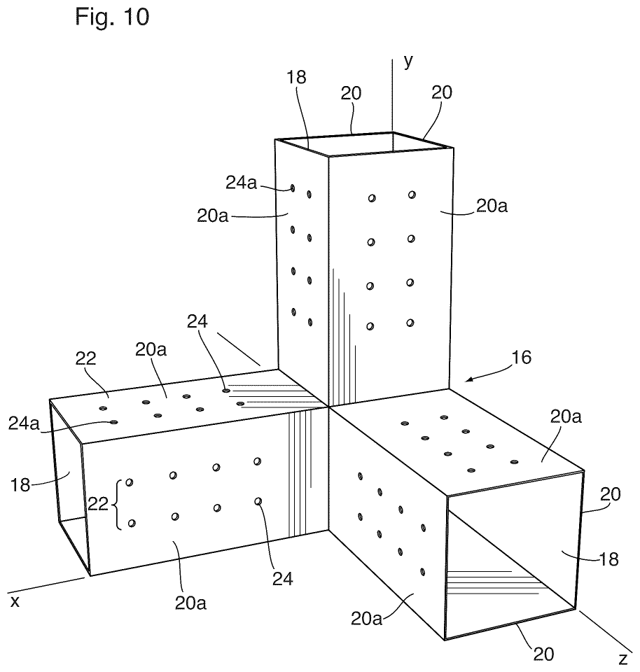

The brackets 16 are formed from metal and have different configurations depending on the number of members 14 to be connected. The brackets 16 have a socket 18 for each of the members to be connected. As can be seen in FIG. 10, a corner bracket 16 to join three members orthogonally has three sockets 18 disposed along orthogonal axes, labelled X, Y, Z. Each of the sockets 18 has an internal dimension corresponding to the external dimension of the structural member 14. Thus, if the bracket 16 is to be used in a framework formed by nominal 4×4 lumber, the socket 18 will be a square cross section dimensioned to snugly receive the structural member 14,

Each of the sockets 18 is formed with 4 planar faces 20. Inwardly directed faces, that is those that are directed toward another face, as indicated at 20a, have an array 22 of holes 24 that extend through to the interior of the socket 18. The array 22 is formed by two rows of four holes 24 that are spaced from one another to provide a grid. It will be appreciated of course that other configurations of array could be used.

Referring again to FIG. 1, the structural members 14 are inserted in to the sockets 18 to provide four legs 14a and four stringers 14b so the legs 14a are disposed at the corners of a rectangle. The members 14 are secured to the respective brackets 16 by screws passing through the distal holes 24a and in to the structural member 14, so that a rigid framework 10 is provided. It will be appreciated that the dimensions of the stringers 14b may be chosen to suit the area to be covered simply by cutting the stringers 14b to the required length.

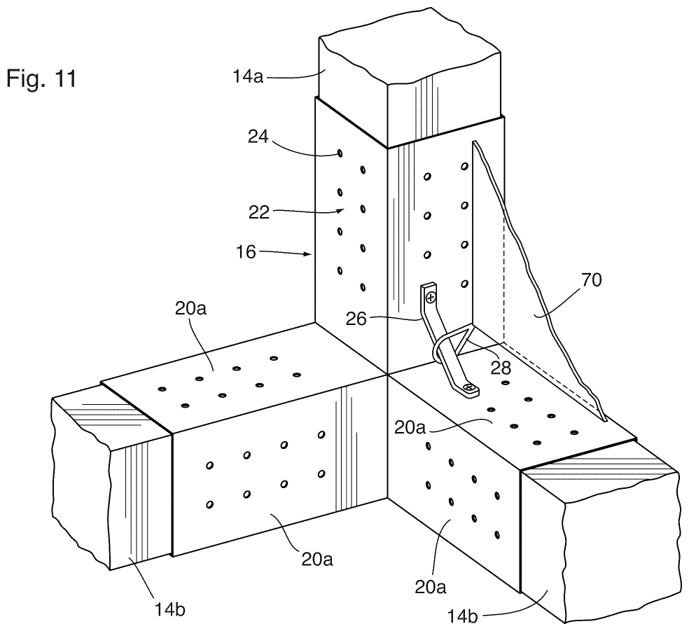

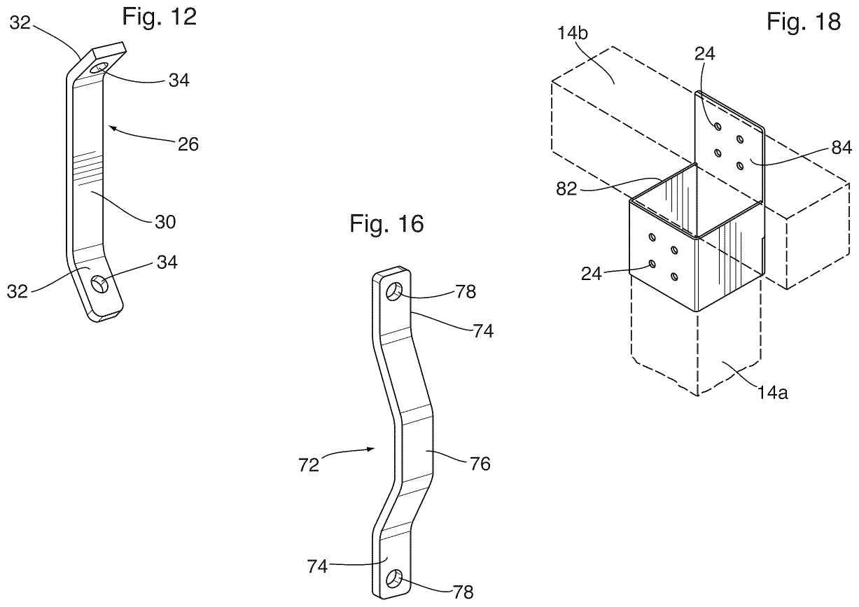

The array 22 of holes 24 is also used to attach the shade cloth 12 to the framework 10. As can be seen in FIG. 11, a hanger 26 extends between a pair of inwardly directed faces 20a and supports an elastic loop 28 secured to a corner of the shade cloth 12 or side panel 70 described below. The hanger 26 is shown in FIG. 12 and has a central body 30 with a pair of end tabs 32 disposed at 45 degrees to the body 30. A hole 34 is formed in each of the end tabs 32. The spacing between the holes 34 is such that they align with holes 24 in adjacent faces 20a so that the hanger may be secured to each of the faces with a screw 36. The screw passes through the hole 24 and in to the member 14 to effect a secure fastening. If preferred, the screws may be self-tapping and dimensioned to engage with the holes 24 as they are inserted to provide a further fastening, but generally the fastening in to the structural member 14 is sufficient. Thus the shade cloth is secured to the framework 10 at each corner and may be readily removed if required by simply releasing the loop 28 while leaving the hanger 26 in situ.

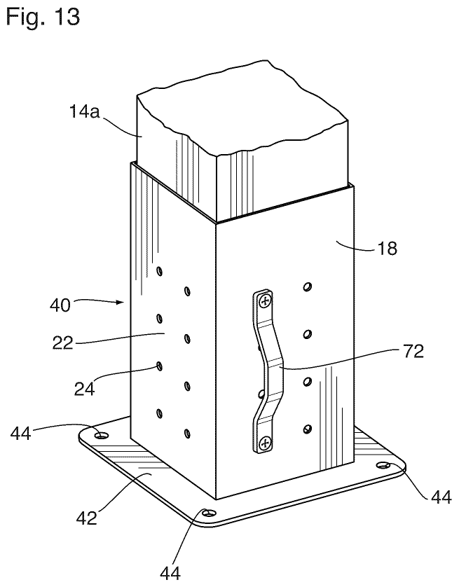

In the embodiment of FIG. 1, the lower end of legs 14a is located to the substrate by feet 40 shown in greater detail in FIG. 13. The feet 40 each have a socket 18 that is secured to a plate 42. The socket 18 has an array of holes 24 formed on one of its faces 20 to allow the foot 40 to be secured to the leg 14a. The plate 40 has bolt holes 44 at each apex to allow the foot to be secured to the substrate if required. 2

It will be appreciated that the framework 10 may be easily disassembled for storage and different lengths of structural members used for different situations.

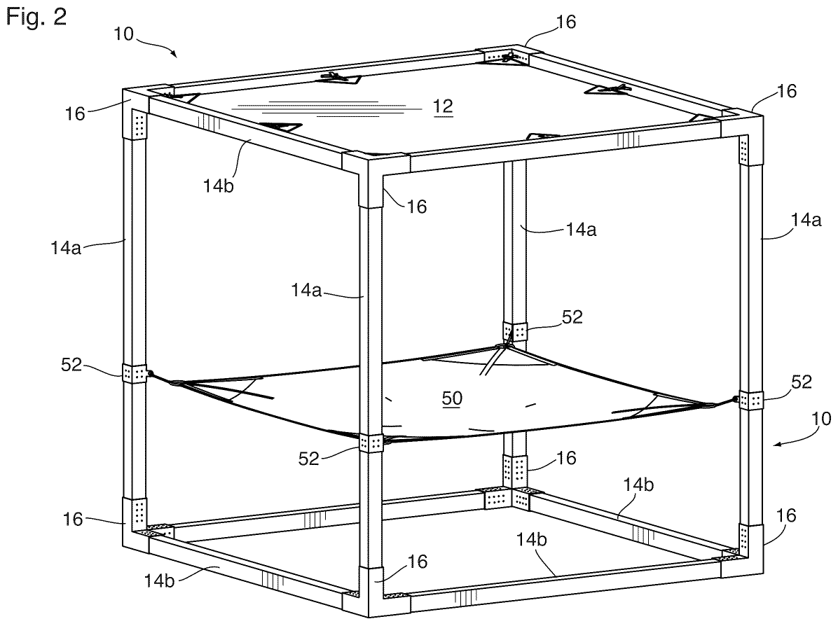

A further embodiment of framework is shown in FIG. 2 in which like reference numerals will be used to denote like components. In the embodiment of FIG. 2, the feet 40 are replaced with corner brackets 16 and stringers 14b inserted to provide a lower peripheral rim. The frame work 10 thus forms a self supporting cube. As in the embodiment of FIG. 1, the shade cloth 12 is secured using hangers 26.

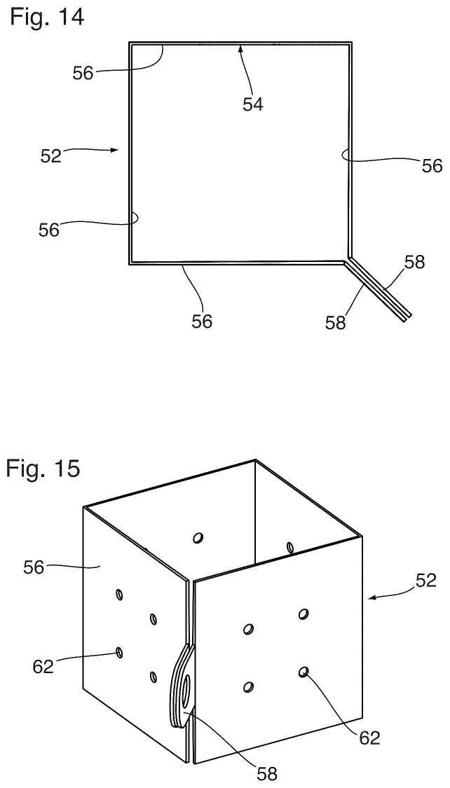

The rigidity of the frame work 10 permits a hammock, 50 to be secured to the legs 14a using a collar 52 shown in greater detail in FIGS. 14 and 15. Collar 52 has an open band 54 with 4 faces 56. The band is dimensioned to fit around the structural member 14 and has a pair of clevises 58 projecting from opposite ends of the band 54. A mounting hole 60 is formed in each clevis. The faces 56 adjacent the clevises 58 are provided with an array of holes 62 that are arranged as a 2×2 grid and of similar size to the holes 24 in the brackets 16.

The collar 52 may be slid along the leg 14a to the required position and screws inserted through the holes 62 to secure the collar in position. Typically, the collar 52 will be located on the leg 14a before assembly of the stringers but mat be retroactively fitted or removed by opening the band 52 to allow the leg 14a to pass between the clevises 58. With the collar located and secured at the required height, the hammock 50 mat be attached to the hole 60 in the clevis using a ring or other suitable fastener. The rigid framework 10 provides a secure attachment for the hammock and the array of holes 62 in the faces of the collar 52 ensures a secure location on the legs 14a.

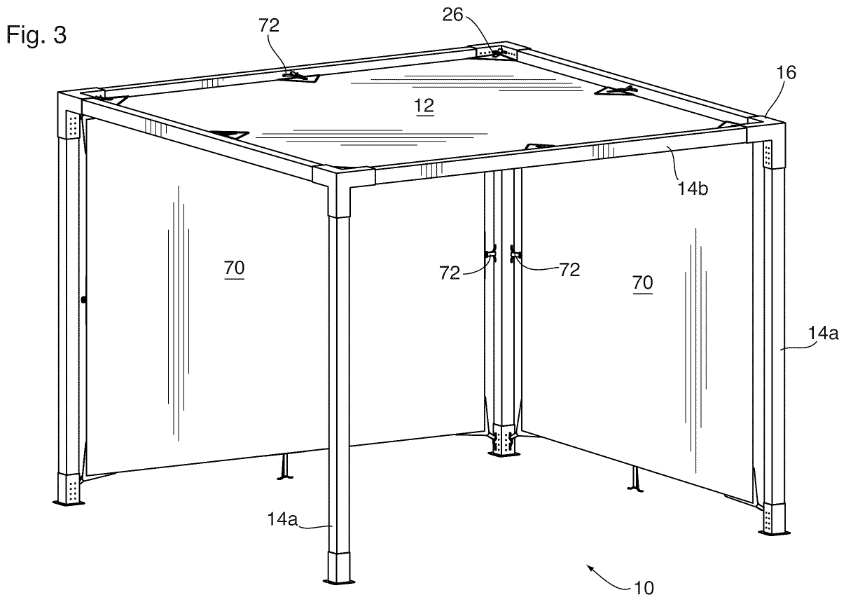

The framework 10 of FIG. 1, or that of FIG. 2 is extra rigidity is required, may also be used to provide side walls as shown in FIG. 3. In the arrangement of FIG. 3, side screens 70 are secured within the vertical apertures formed by a pair of legs 14a and a pair of stringers 14b. A mounting clip 72, shown in greater detail in FIG. 16, is used at each corner and mid span as necessary. The clip 72 is similar to the hanger 26 described above but tabs 74 are oriented parallel with the body 76. Holes 78 are spaced so that they align with a pair of holes in a row on the array of one socket and thus provide a mounting point on either the horizontal or vertical face of the corner bracket 16. The clips 72 are positioned at each corner of the side screens 70, as shown in FIG. 13, and allow the screens to be attached within the apertures. The clips 72 may be attached to either row of holes 24 in the array allowing the side screen to be inset or offset relative to the members 14.

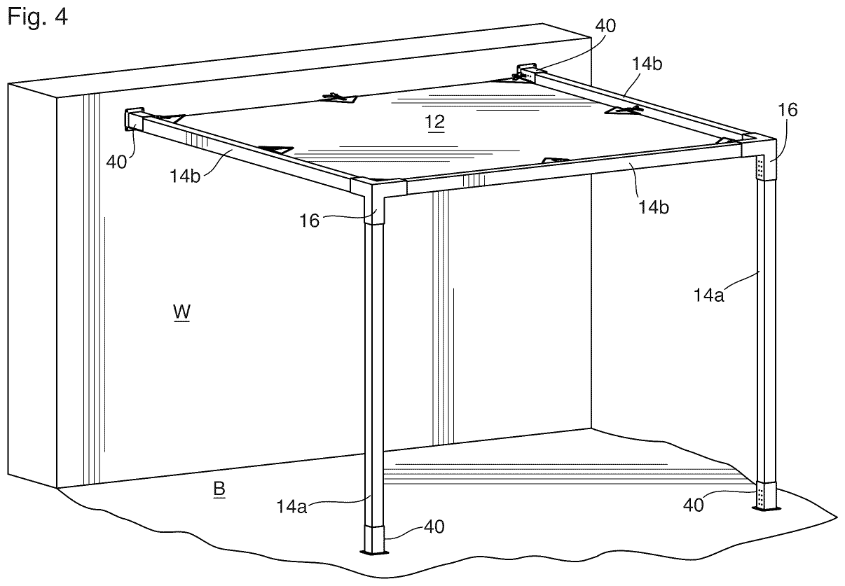

In the above embodiments, the framework 10 is freestanding. However, as shown in FIG. 4. The corner brackets 16 and feet 40 may be used with a surrounding structure to provide a shaded area. In the embodiment of FIG. 4, a pair of legs 14a is used in combination with a pair of stringers 14b to provide an L-shaped frame work. Feet 40 are mounted on the ends of the legs 14a and the stringers to connect the legs 14a to a base B and the stringers to a wall W. A shade cloth 12 is supported by the stringer 14b to provide shade. The connection of the shade cloth to the corner brackets 16 is by way of the hangers 26 as described above. To connect the shade cloth 12 adjacent the wall W, the clip 72 is secured to the array 24 provided on one of the faces of the foot 40. In this case, the face with the array is directed toward the other stringer so the shade cloth may lie within the plane of the stringers.

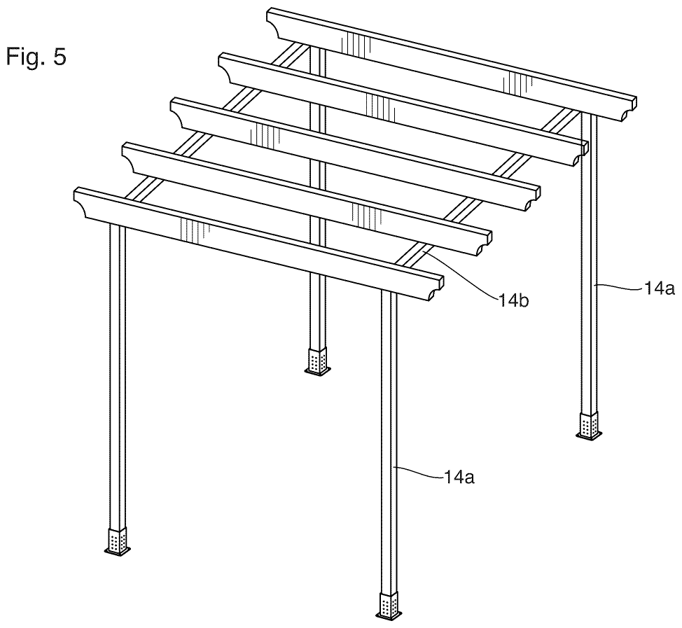

Each of the above embodiments has used a shade cloth 12 to provide shade. In the embodiment of FIG. 5, the stringers 14b are used to support vertical planks at spaced intervals to form a pergola.

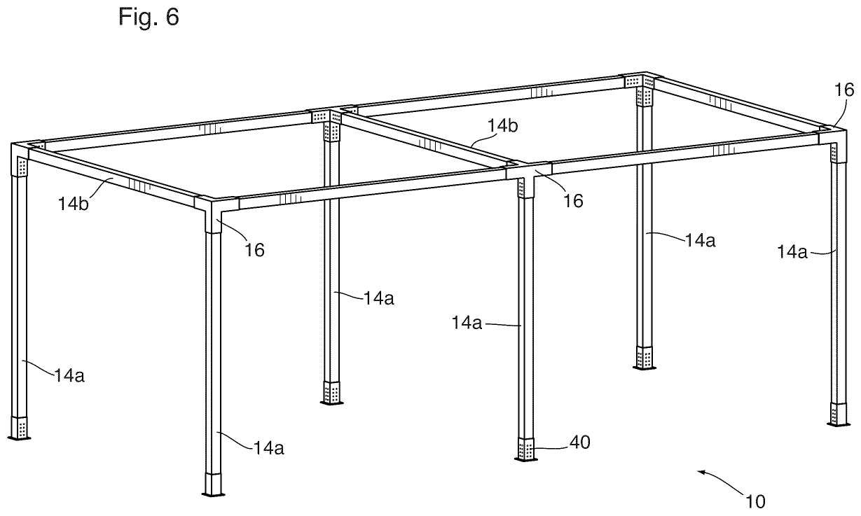

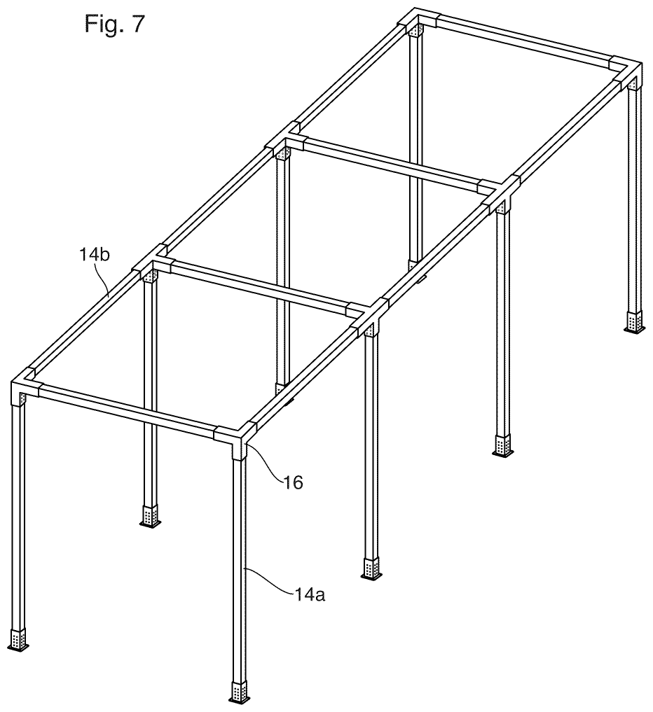

The framework 10 may be used in combination with other frameworks to provide larger structures. As seen in FIG. 6, a pair of structures as shown in FIG. 1 are arranged side by side to provide an enlarged framework. The array of holes at each bracket 16 is available to permit shade cloth or side walls to be attached to the stringers, and of course hammocks can be secured to either or both sets of legs 14a.

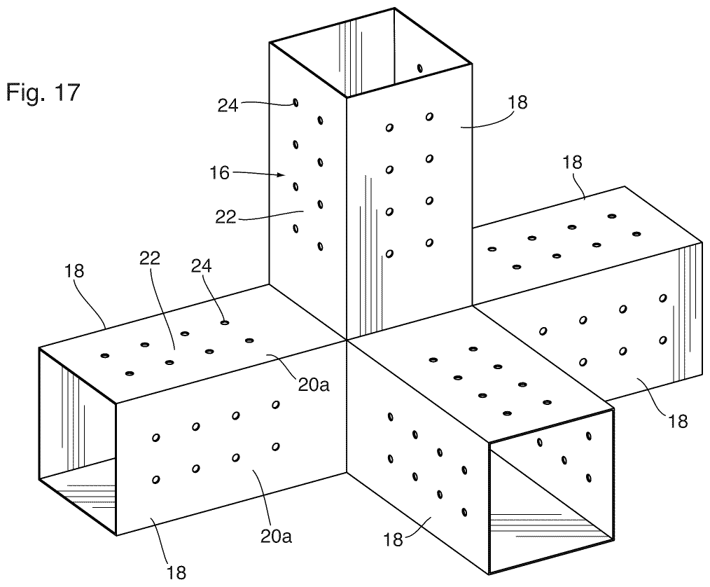

Similarly, in the embodiment of FIG. 7, an open framework as shown in FIG. 1 is connected end to end. In these embodiments, as shown in FIG. 17 the corner bracket 16 is arranged to connect four elongate members 14 on orthogonal axes by proving a socket 18 extending to both sides of the node of the bracket 16. Each of the inwardly directed faces 20a has an array of holes 24 to permit attachment of shade cloth or side walls as required.

The bracket 16 shown in FIG. 17 may also be used with the framework shown in FIG. 4 to provide an extended L-shaped framework support by a wall W.

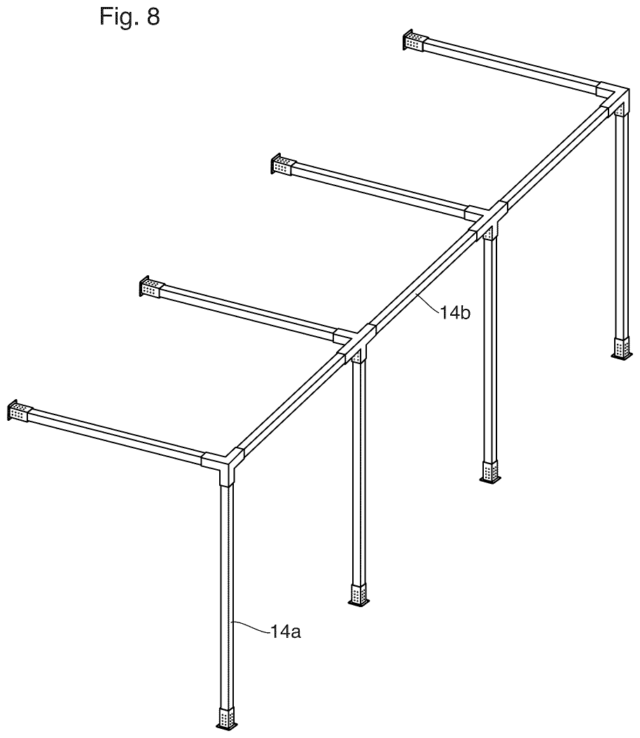

The feet 40 may be adapted for use on soil or sand by providing spikes extending from the sockets 18, as shown in FIG. 9.

The versatility of the framework 10 may be increased by using the connector 80 shown in FIG. 18 to connect a pair of structural members 14 at right angles to one another. The connector 80 has a body defined by a square peripheral wall 82 which is dimensioned to fit over one end of a structural member and a tongue 84 projects from one of the faces of the wall. One face of the wall 82 and the tongue 84 have a 2×2 array of holes 24 so that the body may be secured to one end and the tongue used for connection to another structural member. In this way, as shown in FIG. 18, horizontal rails can be secured between legs 14a and/or pickets can be secured to rails or stringers.

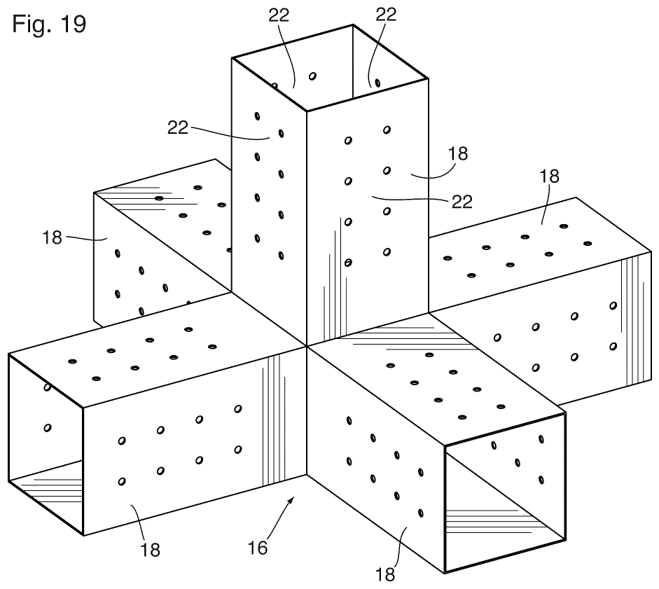

A further embodiment of connector 16 is shown in FIG. 19 that is used to connect 5 structural members 14. Four of the sockets 18 lie in a common plane and the fifth socket 18 is orthogonal to the other sockets. Each of the planar faces 20 of the fifth socket has an array 22 of hole 24 to allow corner hangers 26 or clips 72 to be secured.

In each of the above embodiments it will be recognised that the provision of the array of holes in the inwardly directed faces of the connectors 16 permits not only the structural members to be secured to the brackets for a robust framework, but also allows ancillary components, such as hangers and clips to be attached in a simple manner in a variety of orientations to allow attachment of accessories. The grid defined by the two rows of holes 24 allows base plates of accessories such as light fittings to be secured to the connectors and thereby add to the versatility. The framework is readily disassembled and reconfigured for different purposes or for storage.

The brackets 16 are made from steel or aluminum and can be constructed by welding tubular sections to one another or, preferably, by folding a metal blank in to the required configuration. Where the brackets are folded, it is preferred that the free ends of the blank are mechanically interlocked, such as by a dovetail, after folding to maintain the folded blank in the correct configuration for welding the free ends to one another.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1-4. (canceled)

5. A modular framework having a plurality of elongate structural members interconnected by brackets, each of said brackets being formed as a unitary structure and including a plurality of tubular sockets connected to one another at one end, each of said tubular sockets having a plurality of planar faces that intersect with adjacent planar faces to define a continuous peripheral wall of said socket, said structural members being received within respective ones of said tubular sockets so as to be encompassed by said peripheral wall, said planar faces of each of said sockets including inwardly directed planar faces directed toward a planar face of another socket and outwardly directed planar faces directed away from planar faces of adjacent sockets, each opposed pair of said inwardly directed planar faces on adjacent sockets having an identical array of holes thereon and said outwardly directed planar faces being devoid of such arrays, each of said arrays including a pair of holes spaced apart along a longitudinal axis of said socket to facilitate attachment of said bracket to a respective structural member and to permit connection of an attachment to the bracket to support ancillary components by a fastener passing through a respective hole and into said structural member within said socket.

6. The framework of claim 5 wherein said outwardly directed faces of said sockets are imperforate to provide a smooth exterior surface to said bracket.

7. The framework of claim 5 wherein said structural members are disposed on orthogonal axes and are connected by a respective one of said brackets having a plurality of orthogonally disposed sockets.

8. The framework of claim 5 wherein said array of holes permits connection of an attachment between adjacent planar faces of adjacent sockets to support ancillary components.

9. The framework of claim 5 wherein each array has two sets of holes spaced apart laterally, at least one of said sets having a plurality of holes spaced apart longitudinally, said arrays being disposed on said adjacent planar faces to provide two lines of holes extending between said adjacent sockets to permit connection of an attachment either to one hole of each array to extend between adjacent sockets to support ancillary components or connected to two holes of one array to be supported on one socket, each of said outwardly directed planar faces being imperforate to provide a smooth exterior surface for said bracket.

10. The framework of claim 9 wherein each of said array of holes is arranged in two parallel rows spaced from one another with the holes in each row uniformly spaced apart to define a grid.

11. The framework of claim 10 wherein a hanger extends between a pair of inwardly directed faces and is secured to a hole in each array.

12. The framework of claim 11 wherein a panel is secured to said hanger.

13. The framework of claim 5 wherein said elongate structural members of said framework include a plurality of vertical posts disposed at corners of a polygon and longitudinal stringers extending between said posts, said stringers and posts being connected at each corner by a respective one of said brackets.

14. The framework of claim 13 wherein a panel is secured at each corner by a hanger to provide roof for said framework.

15. The framework of 13 wherein a panel is secured to hangers on a pair of said brackets and to a pair of said posts at locations spaced from the brackets to provide a wall for said framework.

16. A bracket for interconnecting a plurality of elongate structural members in to a modular framework, said bracket being formed as a unitary structure and including a plurality of tubular sockets connected to one another at one end, to receive a respective structural member disposed on the longitudinal axis of said socket, each of said tubular sockets having a plurality of planar faces that intersect with adjacent planar faces to define a continuous peripheral wall of said socket for encompassing the respective structural member when received in said socket, said planar faces including inwardly directed planar faces directed toward a planar face of another socket and outwardly directed planar faces directed away from planar faces of adjacent sockets, each opposed pair of said inwardly directed planar faces on adjacent sockets having an identical array of holes formed thereon and said outwardly directed planar faces being devoid of such arrays, each of said arrays including a pair of holes spaced apart along a longitudinal axis of said socket to facilitate attachment of said bracket to a respective structural member.

17. The bracket of claim 16 wherein said outwardly directed faces are imperforate to provide a smooth exterior surface to said bracket.

18. The bracket of claim 16 wherein the array of holes is arranged in two parallel rows spaced from one another with the holes in each row uniformly spaced apart to define a grid.

19. The bracket of claim 16 wherein each of the sockets are square in cross section.

20. The bracket of claim 16 wherein three sockets are provided on orthogonal axes.

21. The bracket of claim 16 wherein five sockets are provided on orthogonal axes and at least three faces on each socket are inwardly directed to respective faces of the other sockets, each of said three faces having an array of holes.

22. The bracket of claim 16 wherein each of said arrays has two sets of holes spaced apart laterally, at least one of said sets having a plurality of holes spaced apart longitudinally, said arrays being disposed on said adjacent planar faces to provide two lines of holes extending between said adjacent sockets to permit connection of an attachment either to one hole of each array to extend between adjacent sockets to support ancillary components or connected to two holes of one array to be supported on one socket.

23. The bracket of claim 22 wherein each set of holes includes a plurality of holes, said sets being arranged in two parallel rows spaced from one another with the holes in each row uniformly spaced apart to define a grid.

24. The bracket of claim 16 wherein a pair of said adjacent planar faces are mechanically interlocked along a common vertex of said socket.
